(19) United States
(12) Patent Application Publication
(10) Pub. No.: US 2016/0379429 A1
(43) Pub. Date: Dec. 29, 2016

(54) SYSTEM FOR ACCESS CONTROL OF A PLURALITY OF LOCKS

(71) Applicant: EMKA Beschlagteile GmbH & Co. KG, Velbert (DE)

(72) Inventors: Joerg Schultheis, Velbert (DE); Harald Guerth, Luth. Wittenberg (DE)

(21) Appl. No.: 15/192,951

(22) Filed: Jun. 24, 2016

(30) Foreign Application Priority Data
Jun. 24, 2015 (DE) 102015110139.4

(51) Int. Cl. G07C 9/00

(52) U.S. Cl. CPC G07C 9/00309; G07C 2009/00769

(57) ABSTRACT

In a system for access control of battery-operated, electro-mechanical locks, each containing a radio module, at least two access points for wireless communication with the radio modules are provided. The access points receive identification signals that include an identifier of a respective lock and are produced by the radio modules.

The access points further detect simultaneously a parameter of the received identification signal. The identification signal and the detected parameter of the received identification signal are conducted to an evaluation unit formed on one of the access points. The evaluation unit is connected with a control unit. The identification signal received by multiple access points and transmitted by a radio module is conducted only once to the control unit. It can be determined via which of the access points an operating signal produced by the superordinate control unit for the lock is transmitted to the radio module of the lock.

### CROSS-REFERENCE TO RELATED APPLICATIONS

The instant application claims the priority date of Jun. 24, 2015, the filing date of the German patent application DE 10 2015 110 139.4.

### BACKGROUND OF THE INVENTION

The present invention relates to a system for access control of a plurality of battery-operated, electromechanical locks, each containing a radio module, for locking doors.

Systems for wireless access control of multiple locks are known, in which the radio module of the locks can communicate with a radio device. With these types of systems, a user can identify himself by means of an identification code on a lock, whereupon the radio module of the corresponding lock transmits the identifier of the lock and the signal containing the identification code to the radio device. The radio device conducts the signal to a superordinate control unit, which compares the identification code with stored identification codes and in the event of a positive match, transmits a release signal via the radio device to the corresponding lock. After receipt of the release signal, the corresponding lock can be unlocked.

With known systems, the number of locks with which a single radio device can communicate is limited to known amount. If more locks are to be controlled by the radio device than the predetermined maximum number of locks in a room, thus a second system must be installed that includes a radio device and multiple locks. In this regard, it is a disadvantage that the two or more systems to be operated in parallel can disrupt one another in their radio operation, in particular. Furthermore, with known systems, it often is difficult under certain circumstances to position the radio device such that it can communicate each time with all locks distributed in the corresponding room and associated to it. Constant possible radio contact is, in particular, made more difficult in that the strength of the signals transmitted from the radio modules and the radio device vary based on objects brought into the room or in another manner at a specific position in the room. Thus, it could happen that a radio module of a lock can no longer communicate with the radio device associated with it due to an opened door of a closet, although this originally was possible.

### SUMMARY OF THE INVENTION

An object of the present invention, therefore, is to at least partially resolve the problems illustrated with regard to the state of the art and in particular, to make possible a system and a method for access control of large number of locks, in which, in particular, the locks can be exchange simply and new locks can be added and in which a reliable communication between the locks and the superordinate control unit is enabled.

This object is solved by a system and method with the features of the independent claims. Advantageous further embodiments of the system and the method are provided in the dependent claims and in the description, whereby features of the advantageous embodiments can be combined in any manner in a technically sensible manner.

The object is solved, in particular, by a system for access control of a plurality of battery-operated, electro-mechanical locks, each containing a radio module, that lock doors, whereby at least two access points for wireless communication with the radio modules of the locks are provided and the access points are equipped to receive an identification signal produced by the radio modules and which include an identifier of the respective lock and to detect simultaneously a parameter of the received identification signal, whereby the identification signal and the detected parameter of the received identification signal are conducted to an evaluation unit formed at one of the access point, the evaluation unit being connected with a superordinate control unit and equipped such that the identification signal received from multiple access point and transmitted from the radio module of a lock is conducted only one to the superordinate control unit. The evaluation unit is further equipped, such that, depending on the parameters of the respective received identification signals of the lock detected by the access points, it is predetermined via which of the access points an operating signal produced by the superordinate control unit for the lock is transmitted to the radio module of the lock.

The invention relates in particular to a system and a method for access control of locks, which respectively lock the door of a control cabinet or box.

It is also provided, in particular, that the radio module of the lock could communicate with all access points and thus, the identification signal via each access point and the evaluation unit to the superordinate control unit could be determined. In addition, each radio module could receive an operating signal from each access point. The access points are additionally formed and equipped to measure the identification signal as an information signal as well as a physical parameter of the received identification signal. While the identification signal should be the same as such on all access points, the physical parameters of the identification signal at the respective access points differ from one another. The detected parameter of the received identification signal, in particular, is the existing field strength of the identification signal transmitted by the radio module and received by the respective access point. The evaluation unit differs based on the parameter detected by the respective access point, via which access point the operating signal is to be transmitted to the radio module of the corresponding lock. Since the radio module, therefore, is not associated with an individual access point, the system also can be expanded subsequently almost without limit. In addition, the access points can be associated spatially with regard to the locks, so that it is ensured that each radio module can communicate at least with one access point.

The access points are, in particular, radio devices, which, according to industry standards, can send signals to the radio modules of the locks as well as receive signals from the radio modules.

The locks contain an electro-mechanical drive, which can be unlocked according to the content of a release signal of the lock to the extent that a user can open the door provided with the lock. In addition to the radio module for communication with the access points, the lock includes, in particular, a receiver, which can receive an identification code, for example, on an RFID basis or biometrically, so that the identification code can be transmitted to the lock.

Each lock has an identifying identifier, which is transmitted with the identification signal to the access points. However, also the status of the locks (open/closed) or also an identification code transmitted to the lock can be transmitted to the access points.

The access points, in particular, each have a unit, with which a physical signal, in particular the field strength of the received identification signal, is determined.

The evaluation unit that evaluates the identification signal and the detected parameter is integrated into one of the access points. The identification codes which are authorized to open a lock are stored on the superordinate control unit. In addition, it can be documented on the superordinate control unit with which identification code and when which lock should be opened. Further, the superordinate control unit is equipped to evaluate the information transmitted from the respective locks regarding their plausibility.

The operating signal can be an unlocking or release signal, in particular. The operating signal, however, also can include a primary code to be stored or saved on the lock for the respective lock, so that the primary code of a lock can be changed simply after installation of the system based on the superordinate control unit.

Preferably, the system includes at least four access points, particularly preferably, at least eight access points. The system includes, in particular, at most 32 access points, preferably 16 access points at the most. In addition, the system includes at least 64 locks per access point, but at the most 200 locks per access point. Further, the system includes a total of 4,000 locks at the most, preferably 2,000 locks at the most.

In particular, it is provided that the evaluation unit is equipped such that the operating signal is transmitted to the radio module of the lock via that access point which has received the identification signal with the greatest field strength as the parameter. In this manner, an operating signal is sent via that access point which has the best radio connection to the respective radio module.

In this connection, it can be provided that the evaluation unit is equipped, such that the operating signal is transmitted via a different access point when a maximum transmission time of the access point, which has received the identification signal with the largest field strength, is used. This is to be used, in particular, when the access point no longer may transmit a signal in a determined time interval based on legal specifications.

In particular, each radio module is equipped such that it transmits an identification signal if it were activated by a user, in particular if it were aviated via a sensor that determines a capacitance change. In particular, an identification code is transmitted in such a case with the identification signal which contains information about which user has activated the radio module.

In order to enable a periodic monitoring of the state of the locks, while simultaneously using the least possible energy of the batteries of the locks, it can be provided that each radio module is equipped, such that an identification signal is transmitted periodically at an interval of at least one hour, preferably at least three hours. In this case, the identification signal includes, in particular, a status information of the lock. This status information can contain information, for example, as to whether the lock is open or closed. The status information, however, also can include the charging state of the battery and/or at least one primary code of the lock.

In order to further reduce the energy consumption of the lock, it is provided that the radio module remains ready-to-receive after transmission of the identification signal for three minutes at the most, preferably, for 30 seconds at the most.

In particular, it is provided that with the identification signal, an identification code that is transmitted to the lock is radioed and after a positive matching of the identification code in the superordinate control unit with a predetermined identification code, a release signal is transmitted to the lock. Thus, a user can identify himself with the identification code on the lock and thereupon, the lock can be unlocked immediately.

On the other hand, it can be provided that a lock can be released by the superordinate control unit, without requiring an identification code, in which case, a release signal for a lock is produced by the superordinate control unit and is transmitted to the evaluation unit, and upon presentation of an identification signal by this lock to the evaluation unit, the release signal is transmitted to this lock. The lock, therefore, is unlocked first after activating by the user, without the user having to identify himself.

So that in the event of an interruption or breakdown or in the event of a power outage each lock can be unlocked, it can be provided that each lock can be unlocked by means of a primary code the can be transmitted to the lock, even if no release signal from the superordinate control unit is present. The primary code is, in particular, transmittable biometrically or by means of RFID technology to the lock. Independently of the previously described invention, in this connection, a separate invention is contemplated, in which in a delivery status of the lock, a general manner of identification can be provided with which the lock can be unlocked. For example, a specific group of codes can be provided, with which the lock can be unlocked. In particular, a type of card also could be provided, with which the lock can be unlocked. After the corresponding lock, however, has communicate the first time via the access points with a superordinate control unit, a new primary code or multiple primary codes are transmitted to the lock, with which the lock thereupon can be unlocked without a release signal. The originally provided manner of identification, therefore, is irrevocably overwritten. This has the advantage that the lock can be unlocked first for a plurality of users (for example, the installer) and thus can be tested, whereby after installation of the entire system, still the then permitted user can unlock the locks with a primary code, without requiring a release signal from the superordinate control unit.

The object also is solved with a method for access control of a plurality of battery-operated, electro-mechanical locks, each containing a radio module, for locking doors by means of at least two access points for wireless communication with the radio modules of the locks, including at least the following steps:

transmitting an identification signal that includes an identifier of the respective lock through the radio module of the lock;

receiving the identification signal by at least one of the access point and detecting a parameter of the received identification signal at the access point;

conducting the identification signal and the detected parameter of the received identification signal to an evaluation unit formed on one of the access points;

conducting once the identification signal from the evaluation unit to a superordinate control unit connected with the evaluation unit;

producing an operating signal by means of the superordinate control unit for one of said locks and transmitting the operating signal to the evaluation unit;

conducting the operating signal by means of the evaluation unit to only one of the access points;

transmitting a release signal from the access point to the radio module of the lock,

wherein the evaluation unit determines, depending on the parameters detected by the access point of the respectively received identification signal of the lock via which access point the release signal is sent to the radio module of the lock. The above-noted steps preferably can be performed in the described sequence; however, the steps also can be performed in any sequence that makes sense based on technical considerations.

The identification signal is conducted only once from the evaluation unit to the superordinate control unit, so that the data traffic is reduced.

In particular, the operating signal is transmitted to the lock via that access point which has received the identification signal with the greatest field strength.

If a maximum transmission time of this access point is used, however, the operating signal is transmitted, in particular via a different access point.

In particular, an identification signal is transmitted if the radio module of the corresponding lock is activated by a user.

In addition, it can be provide that an identification signal is transmitted periodically at intervals of at least one hour.

In particular, an identification code transmitted to the lock is transmitted with the identification signal and compared with a predetermined identification code in the superordinate control unit, whereby, after a positive matching, a release signal is transmitted to the lock.

Alternatively, it can be provided that a release signal is produced at the superordinate control unit and is transmitted to the evaluation unit, whereby after verification of an identification signal by this lock to the evaluation unit, the release signal is transmitted to this lock.

Preferably, the lock can be unlocked by means of a primary code, even if no release signal is present from the superordinate control unit.

### BRIEF DESCRIPTION OF THE DRAWING

FIG. 1 is a schematic representation of the system for access control according to the present invention.

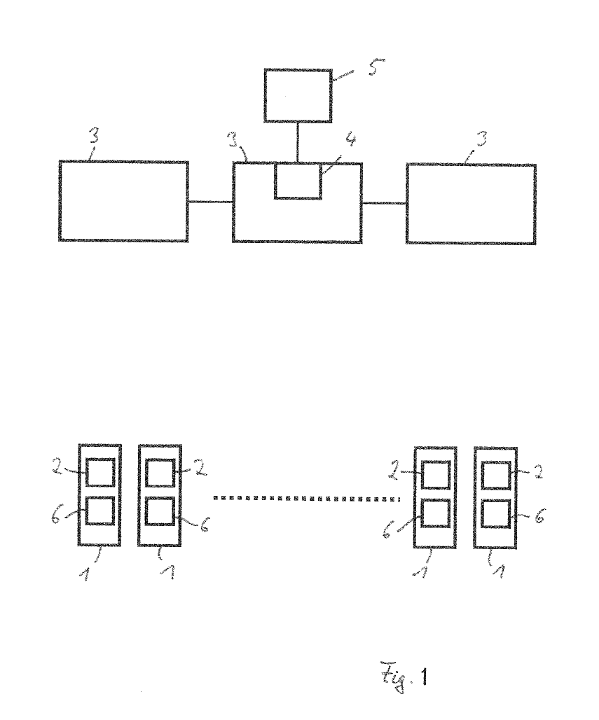

### DETAILED DESCRIPTION OF THE PREFERRED EMBODIMENTS

The FIGURE schematically shows a system with a superordinate control unit 5, which communicates with an evaluation unit 4 formed on an access point 3. With the illustrated system, three access points 3 are provided. The system includes additionally a plurality of battery-operated locks 1, each of which has a respective radio module 2 and a sensor 6. The radio module 2 can be activated via the sensor 6 and an identification code can be transmitted to the lock 1. The locks 1 can communicate via the radio module 2 with the access points 3.

It is therefore provided that the radio module 2 upon activation transmits an identification signal including an identifier and if necessary, an identification code obtains via the sensor 6, whereby this identification signal is received by the access points 3. The access point 3 in turn detect, respectively, the prevailing field strengths of the identification signal as a parameter during receipt of the identification signal and conducts the identification signal as well as the detected field strength as a parameter to the evaluation unit 4. The evaluation unit 4 in turn conducts the identification signal, which if necessary contains the identification code, to the superordinate control unit 5. The superordinate control unit 5 compares the identification code and if necessary, also the identification signal with the identification code stored on the superordinate control unit. After a positive matching, the superordinate control unit transmits a release signal to the evaluation unit 5. The evaluation unit 4 conducts the release signal to that access point 3, which previously has received the identification signal transmitted by the lock 1 with the greatest field strength. Thus the radio module 2 of the lock 1 receives the release signal with a highest possible field strength. After receipt of the release signal, the lock is unlocked automatically, so that a user can open a door that is lockable by the lock 1.

The specification incorporates by reference the disclosure of DE 10 2015 110 139.4, filed Jun. 24, 2015.

The present invention is, of course, in no way restricted to the specific disclosure of the specification and drawings, but also encompasses any modifications within the scope of the appended claims.

### REFERENCE NUMERAL LIST

1 Lock
2 Radio module
3 access point
4 evaluation unit
5 superordinate control unit
6 sensor

We claim:

1. A system for access control of a plurality of battery-operated, electro-mechanical locks (1) for unlocking doors, comprising:
a plurality of radio modules (2), wherein one of said radio modules (2) is disposed in each of said locks (1);
at least two access points (3) for wireless communication with the radio modules (2) of the locks (1), wherein the access points (3) are configured to receive identification signals produced by the radio modules (2), said identification signals including an identifier of a respective one of said locks (1), wherein said access point (3) are further configured to detect simultaneously a respective parameter of the received identification signals;
an evaluation unit (4) formed on one of the access points (2), wherein the identification signal and the detected respective parameter of the received identification signals are conducted to the evaluation unit (4);
a superordinate control unit (5), wherein the evaluation unit (4) is connected with the superordinate control unit (5), wherein the evaluation unit (4) is configured such that the identification signals received by multiple access points (3) and transmitted by a respective one of the radio modules of one of said locks lock (1) are conducted, respectively, only once to the superordinate control unit (5), wherein depending on the parameters of the respectively received identification signal of the lock (1) detected by the access points (3), it is determined via which of the access points (3) an operating signal produced by the superordinate control unit (5) for the lock (1) is transmitted to the radio module (2) of the lock (1).

2. The system according to claim 1, wherein the evaluation unit (4) is configured, such that the operating signal is transmitted via one of said access points that received the identification signal with the greatest field strength as a parameter.

3. The system according to claim 2, wherein the evaluation unit (4) is configured such that the operating signal is transmitted via a different access point (3) when a maximum transmission time of the access point (3) that received the identification signal with the greatest field strength is used.

4. The system according to claim 1, wherein each radio module (2) is configured such that it transmits an identification signal when it is activated by a user.

5. The system according to claim 4, wherein the identification signal is transmitted via a sensor (6) that determines a capacitance change.

6. The system according to claim 1, wherein each radio module (2) is equipped, such that it transmits an identification signal periodically at intervals of at least one hour.

7. The system according to claim 4, wherein the radio module (2) remains ready-to-receive for a period of up to three minutes after transmitting the identification signal.

8. The system according to claim 1, wherein an identification code that is transmitted to the lock is transmitted with the identification signal and after positive matching of the identification code in the superordinate control unit (5) with a provided identification code, a release signal is transmitted to the lock (1).

9. The system according to claim 1, wherein a release signal for a selected one of said locks (1) is produced by the superordinate control unit (5) and is transmitted to the evaluation unit (4) and after confirmation of an identification signal by said selected one of said locks (1) to the evaluation unit (4), the release signal is transmitted to said selected one of said locks (1).

10. The system according to claim 1, wherein each of said locks is unlockable via a primary code transmittable to each of said locks (1), even if no release signal from the superordinate control unit (5) is present.

11. A method for access control of a plurality of battery-operated, electro-mechanical locks (1) for locking doors, each of said locks (1) containing a radio module (2), via at least two access points (3) for wireless communication with the radio modules (2) of the locks (1), including at least the following steps:
transmitting an identification signal that includes an identifier of a respective one of said locks (1) via the radio module (2) of the respective one of said locks (1);
receiving the identification signal by at least one of the access points (3) and detecting a parameter of the received identification signal at the at least one of the access points (3);
conducting the identification signal and the detected parameter of the received identification signal to an evaluation unit (4) formed on one of the access points (3);
conducting once the identification signal from the evaluation unit (4) to a superordinate control unit (5) connected with the evaluation unit (4);
producing an operating signal via the superordinate control unit (5) for the respective one of said locks (1) and transmitting the operating signal to the evaluation unit (4);
conducting the operating signal by means of the evaluation unit (4) to only one of the access points (3);
transmitting a release signal from the access point (3) to the radio module (2) of the respective one of said locks (1),
wherein the evaluation unit (4) determines, depending on the parameters detected by the access point of the respectively received identification signal of the respective one of said locks (1) via which access point (3) the release signal is sent to the radio module (2) of the respective one of said locks (1).
